(19) United States
(12) Patent Application Publication
(10) Pub. No.: US 2026/0075202 A1
(43) Pub. Date: Mar. 12, 2026

(54) LATENT CODING FOR END-TO-END IMAGE/VIDEO COMPRESSION

(71) Applicant: InterDigital CE Patent Holdings, SAS, Paris (FR)

(72) Inventors: Franck Galpin, Thorigne-Fouillard (FR); Fabien Racape, San Francisco, CA (US); Frederic Lefebvre, Rennes (FR); Muhammet Balcilar, Betton (FR)

(21) Appl. No.: 19/120,666

(22) PCT Filed: Oct. 3, 2023
(86) PCT No.: PCT/EP2023/077325

§ 371 Date: Apr. 11, 2025

(30) Foreign Application Priority Data
Oct. 12, 2022 (EP) 22306547.5

(51) Int. Cl. H04N 19/13; H04N 19/14; H04N 19/196

(52) U.S. Cl. CPC H04N 19/13; H04N 19/14; H04N 19/196

(57) ABSTRACT

In end-to-end compression, a deep neural-network based encoder can be used to encode an image. The embeddings output from the encoder are quantized and encoded with a lossless encoder. Advantageously, at least one embodiment allows improving the latent entropy coding by further reducing the redundancies in the quantized latent. To that end, at least one embodiment discloses taking into account channels importance by coding an indication of a channel activity (or significance): performing post-conditional entropy coding by computing conditional probability based on a context afterwards: using channels reordering to improve inter channel correlation: or performing RDOQ like process by optimizing the main latent for a particular image.

### CROSS REFERENCE TO RELATED APPLICATIONS

This application claims the benefit of European Patent Application No. 22306547.5, filed on Oct. 12, 2022, which is incorporated herein by reference in its entirety.

### TECHNICAL FIELD

The present embodiments generally relate to a method and an apparatus for end-to-end neural compression of images and videos.

### BACKGROUND

End-to-end compression is a compression technique where all components of the processes are learned from given data. End-to-end means that everything is learned from one end (given data) to another end (compressed bitstream). Once the architecture is defined for end-to-end compression, there is no manual engineering work on designing the steps. End-to-end neural compression methods are not standardized yet. Currently MPEG is exploring these technologies.

### SUMMARY

In end-to-end compression, a deep neural network-based encoder can be used to encode an image. The embeddings output from the encoder are quantized and encoded with a lossless encoder. Advantageously, at least one embodiment allows improving the latent entropy coding by further reducing the redundancies in the quantized latent. To that end, at least one embodiment discloses taking into account channels importance by coding an indication of a channel activity (or significance); performing post-conditional entropy coding by computing conditional probability based on a context afterwards; using channels reordering to improve inter channel correlation; signaling activity of channels on image/blocks or performing RDOQ like process by optimizing the main latent for a particular image.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of a generic embodiment of an end-to-end neural-network-based video compression system.

FIG. 3 illustrates a training loop of an end-to-end neural-network-based video compression system according to an embodiment.

FIG. 4 illustrates an encoding process of an end-to-end neural-network-based video compression system according to an embodiment.

FIG. 5 illustrates a decoding process of an end-to-end neural-network-based video compression system according to an embodiment.

FIG. 6 illustrates a structural block diagram of the generic embodiment of FIG. 2.

FIG. 7 illustrates a representation of a latent tensor in a neural-network-based video compression system to which aspects of the present embodiments may be applied.

FIG. 8 illustrates an encoding process of an end-to-end neural-network-based video compression system according to an embodiment.

FIG. 9 illustrates an encoding process of an end-to-end neural-network-based video compression system according to an embodiment.

FIG. 10 illustrates a representation of a latent tensor in a neural-network-based video compression system to which aspects of the present embodiments may be applied.

FIGS. 11 and 12 illustrate a representation of a receptive field of latent tensor according to at least one embodiment related to RDOQ.

FIG. 13 shows two remote devices communicating over a communication network in accordance with an example of present principles in which various aspects of the embodiments may be implemented.

FIG. 14 shows the syntax of a signal in accordance with an example of present principles.

### DETAILED DESCRIPTION

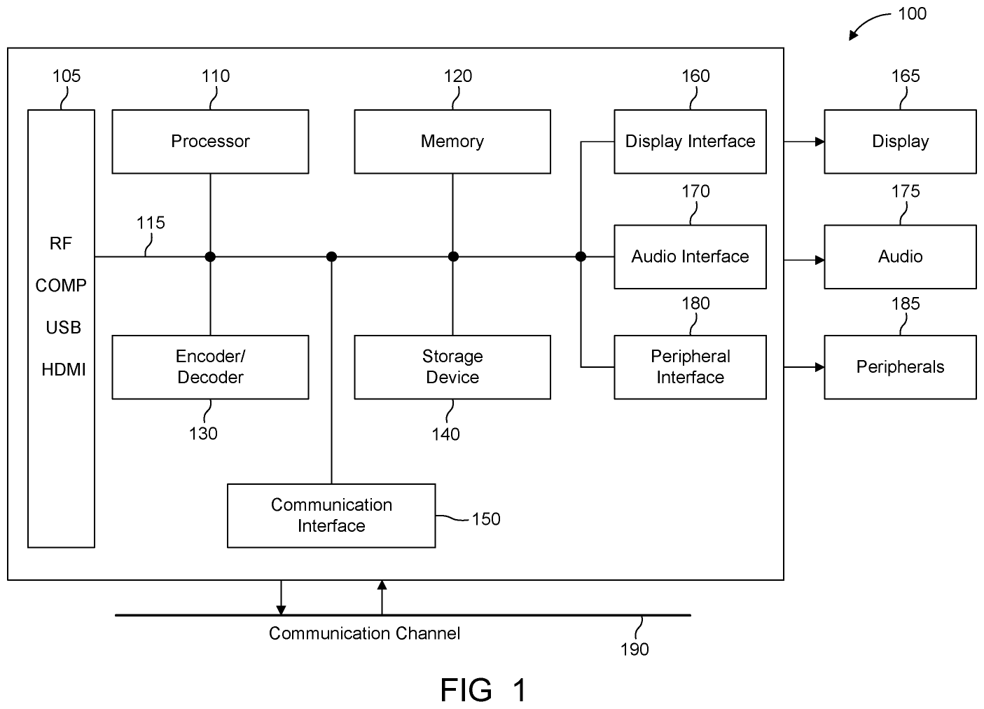

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-4, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

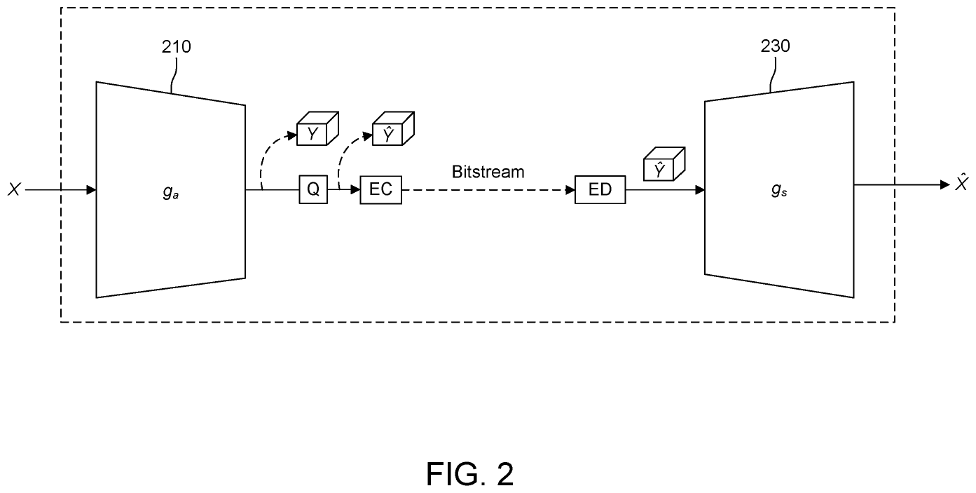

FIG. 2 illustrates a block diagram of an embodiment of an end-to-end neural-network-based video compression system. The variant embodiment of FIG. 2 consists in a high-level simplified version of end-to-end NN. The input X to the encoder part of the network can consists of an image or frame of a video, a part of an image, a tensor representing a group of images, a tensor representing a part (crop) of a group of images.

In each case, the input can have one or multiple components, e.g.: monochrome, RGB or YCbCr components. In a first step, the input X is fed into the encoder network 210 which applies the function gₐ ( ) also known as analysis transform. gₐ ( ) is usually a sequence of convolutional layers with activation functions. Large strides in the convolutions or space-to-depth operations can be used to reduce spatial resolution while increasing the number of channels. The encoder network 210 can be seen as a learned transform. In a next step, the output of the analysis transform: Y=gₐ (X), the 3-way array or 3-dimensional tensor (referred to as a tensor), of latent variables or latent representation Y, is quantized (Q) and entropy coded (EC) as a binary stream (bitstream) for storage or transmission. For sake of ease of the notation in this embodiment, it is assumed that EC embeds the quantization operation Q. Then, the bitstream is entropy decoded (ED) to obtain Ŷ, the quantized version of Y. The decoder network 230, which applies the function gₛ ( ) also known as synthesis transform, generates a reconstructed input: \hat{X}=gₛ (Ŷ), an approximation of the original X from the quantized latent representation Ŷ. gₛ ( ) is usually a sequence of up-sampling convolutions (e.g.: “deconvolutions” or convolutions followed by up-sampling filters) or depth-to-space operations. The decoder network can be seen as a learned inverse transform, or a denoising and generative transform.

The encoder network is usually composed of a sequence of convolutional layers with stride, allowing to reduce spatial resolution of the input while increasing the depth, i.e.: the number of channels of the input. Pooling (e.g., Average Pooling, Max Pooling, etc.) or Squeeze operations (space-to-depth via reshaping and permutations where for example a tensor of size (N, H, W) is reshaped and permuted to a tensor of size (N*2*2, H//2, W//2)) can also be used instead of stride convolutional layers. The encoder network can be seen as a learned transform. The output of the analysis, mostly in the form of a 3-way array, referred to as a 3-D tensor is called a latent representation or a tensor of latent variables. From a broader perspective, a set of latent variables constructs a latent space, which is also frequently used in the context of neural network-based end-to-end compression. The latent representation is quantized, and entropy coded for storage/transmission, depicted as the EC block in FIG. 2. The bitstream is the set of coded syntax elements and payloads of bins representing the quantized symbols, transmitted to the decoder.

The decoder first decodes ED quantized symbols from the bitstream. The decoded latent representation is then transformed into pixels for output through a set of layers usually composed of (de-)convolutional layers (or depth-to-space squeeze operations). The decoder network is thus a learned inverse transform operation on quantized coefficients. The output of the decoder is the reconstructed image or a group of images x.

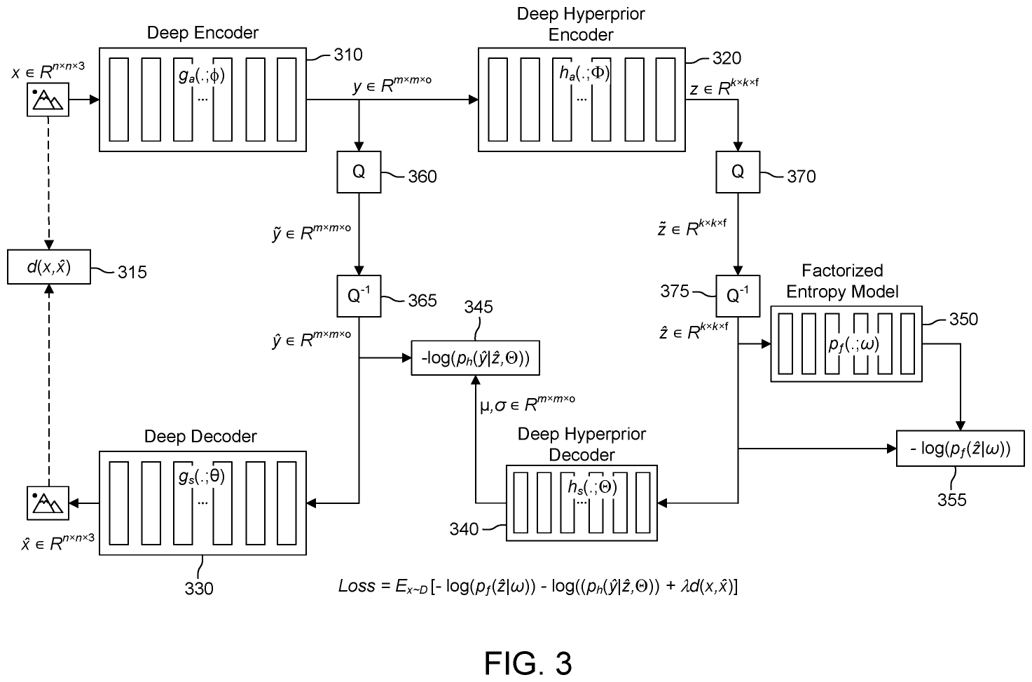

According to another embodiment, more sophisticated end-to-end neural-network-based video compression system exists. For example, a “hyper-autoencoder” (hyper-prior) may be added to the network to jointly learn the parameterized distribution of the latent representation as the output of the encoder. FIG. 3-5 illustrate another embodiment of end-to-end neural-network-based video compression system including hyper-prior and will be described hereafter. Therefore, the present principles are not limited to the use of autoencoders. Any end-to-end differentiable codec can be considered.

FIG. 3 illustrates the training phase of a sophisticated end-to-end compression system. An input image to be compressed, x∈R^{n×n×3}, is first processed by a deep encoder (210) with y=gₐ (x; φ), where φ is a trainable parameter of function gₐ to be optimized during the training phase. The output of the encoder, y∈R^{m×m×o}, is called the main embedding (or main latents) of the image. Here without loss of generality, we assume the image is square (n×n) and the main embedding is also square (m×m). However, they do not need to be square and can be in any shape. The input image can be fed to the encoder at the image level or be partitioned into image regions with the individual image region as input to the encoder.

Then y goes to the quantizer (360) as \tilde{y}=Q(y) to obtain main codes of the image, followed by dequantization block ŷ=Q⁻¹ (\tilde{y}) (365) to obtain reconstructed main latents ŷ. State of the art neural models use the hyperprior entropy model. In particular, the side embedding (or side latents) z∈R^{k×k×f} is learned by another deep neural network (320) by z=hₐ (y; Φ), where Φ is a trainable parameters of function hₐ to be optimized during the training phase, and the side embedding is quantized (370) by \tilde{z}=Q(z) to obtain side codes \tilde{z}, followed by dequantization \hat{z}=Q⁻¹ (\tilde{z}) (375) to obtain reconstructed side latents \hat{z}. These \hat{z} are used to learn the probability model of ŷ. Typically, ŷ can be modelled by Gaussian distribution where the parameters are obtained by another deep network (340) such as [μ,σ]=hₛ (\hat{z}; Θ). The decompressed image \hat{x}∈R^{n×n×3} is obtained by a deep decoder (330) with \hat{x}=gₛ (ŷ; θ).

The values of m and k depend on the defined architecture, and m usually is 1/16 of the image's spatial resolution, and k is usually ⅛ of the embedding's size. The value of o is fixed at 128 for instance in most common architectures. In one example, if the image size is 256×256×3, usually y will be 16×16×128 and z will be 2×2×128.

In this model, the lower bound of bitlength of side codes z is calculated by the factorized entropy model (350). This model accepts \hat{z} as input and learns the probability density function (PDF) of the side codes \tilde{z}. Using this PDF, the model calculates the probability mass function (PMF) of each code under a certain quantization method. PMF values are enough to calculate the lower bound of the bitlength of side codes. On the other hand, the lower bound of the bitlength of main codes y is calculated by the hyperprior entropy model. This model is usually implemented by Gaussian distribution. Basically, each reconstructed main latent (ŷᵢ) in ŷ is supposed to follow Gaussian distribution where the parameters (μᵢ, σᵢ) are obtained by side information in the previous step. Thus, these Gaussian's PMF under the determined quantization method is enough to calculate the lower bound of the bitlength of main codes.

In this setting, the deep encoder (gₐ (.;φ), deep decoder (gₛ (.; θ)), deep hyperprior encoder (hₐ (.; Φ)), deep hyperprior decoder (hₛ (.; Θ)) and factorized entropy model p_{f}(.; ω) are composed of multiple neural layers, such as convolutional layers. Each neural layer can be described as a function that first multiplies the input by a tensor, adds a vector called the bias and then applies a nonlinear function on the resulting values. The shape (and other characteristics) of the tensor and the type of non-linear functions are called the architecture of the network. We will denote the values of the tensor and the bias by the term “weights”. The weights and, if applicable, the parameters of the non-linear functions, are called the parameters. The architecture and the parameters define a “model”. As described above, we denote their parameters by φ, θ, Φ, Θ and ω.

Many end-to-end architectures have been proposed recently. Typically, they are even more complex than what is illustrated in FIG. 3, but they all retain the deep encoder and decoder. State of the art models can compete with traditional codecs in terms of rate distortion tradeoffs.

A model must be trained on massive databases D of images to learn the weights of the encoder, decoder and entropy models. Typically, the weights are optimized to minimize a training loss:

$$Loss = {E}_{x \sim D} [ - log ( {p}_{f} ( \hat{z} \vert ω ) ) - log ( {p}_{h} ( \hat{y} \vert \hat{z} , Θ ) ) + λ d ( x , \hat{x} ) ] ,$$

where d (.,.) (315) is a measure of the distortion between the original and the reconstructed image (for example the mean square error). The rate term (355, 345) is the sum of the lower bound of the bitlength of side information (−log (p_{f} (\hat{z}|ω))) and the lower bound of the bitlength of main information (−log (pₕ (ŷ|\hat{z}, Θ))). Hyperparameter/controls the trade-off between the rate (r) and distortion (d) terms. Note here the rate is based on the lower bound of the bitlength of main information and side information, but other methods can be used to estimate the rates.

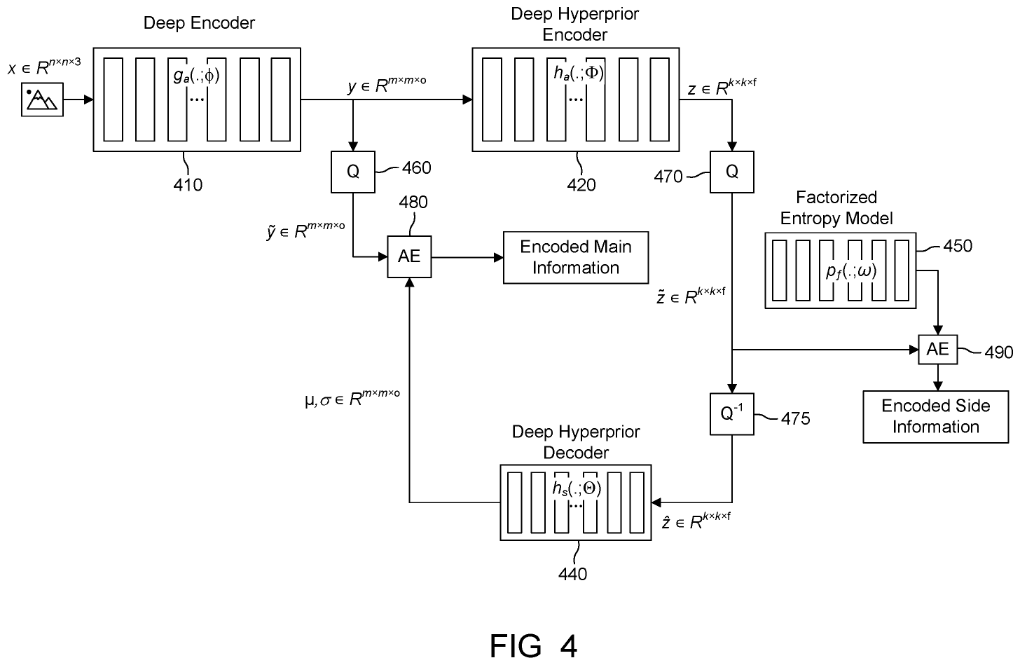

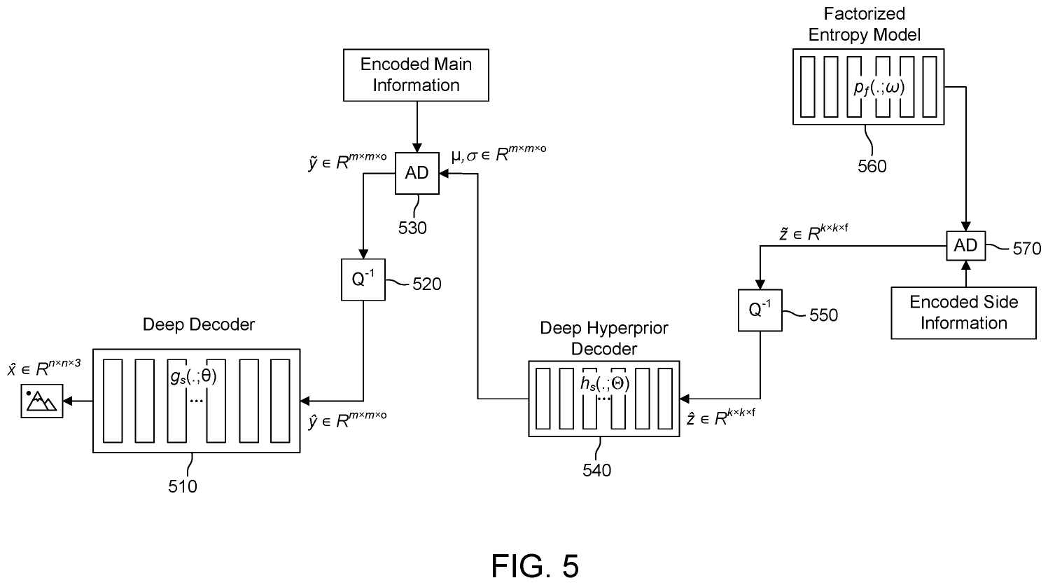

When this model is trained and the optimal parameters (φ, θ, ω, Φ, Θ) are obtained, the model is deployed in encoding and decoding devices as illustrated in FIG. 4 and in FIG. 5, respectively. This phase is usually called test phase. In the test phase, both encoding and decoding devices need PMF tables. Besides the PMF table, encoding and decoding devices must agree on which quantization method is used as well.

FIG. 4 illustrates an encoding process of an end-to-end neural-network-based video compression system according to a particular embodiment. As illustrated in FIG. 4, in the encoding device, main codes and side codes are obtained (410, 420) from a given image by the same way as in the training phase. Later, the encoding device converts the side codes into a bitstream by a lossless encoder, for example, an arithmetic encoder AE (490) driven by the learned PMF tables provided by the factorized entropy model (450). Side codes obtained from quantization (470) are dequantized (475) and reconstructed side latents are obtained in the next step. A hyperprior entropy decoder (440) decodes reconstructed side latents in order to find the distribution of main codes. Finally main codes obtained from quantization (460) are converted into bitstream by a lossless encoder, for example, an arithmetic encoder AE (480) using these distributions. Finally, these two bitstreams are concatenated with some pointer in between.

FIG. 5 illustrates a decoding process of an end-to-end neural-network-based video compression system according to a particular embodiment. As illustrated in FIG. 5, in the decoding device, the process starts with decoding of side codes from the bitstream, which can be done by a lossless decoder, for example, an arithmetic decoder AD (570) by using the learned PMF tables provided by the factorized entropy model (560). The side codes are dequantized (550) and reconstructed side latents are obtained in the next step. A hyperprior entropy decoder (540) accepts reconstructed side latents as input in order to find the distribution of the main codes. These distributions inform the AD (530) how to read the main codes from the bitstream. Dequantization (520) is then applied on the main codes to reconstruct the main latents. The decoding device can get the reconstructed image by feeding the deep decoder (510) with the reconstructed main latents.

Despite the fact there is no restriction on the input format of the autoencoders as stated earlier, most existing approaches take an entire image or frame as input to transform into the latent representation Y as presented in FIGS. 2-5. In such cases, the latent representation represents a 3-dimensional tensor in the latent space by transforming the input image through (non-) linear transformation with number of convolutional layers followed by activation. It implies that spatial redundancy is decomposed solely through the learned transformation operation, which limits not only the coding efficiency, but also the application of compression. Besides, although we refer to the example of image compression, the present principles apply to any compression model that derives and encodes a latent representation from input contents such as motion fields, depth maps, 3D scenes, etc.,

In current approaches, such Artificial Neural Networks (ANNs) are trained using several types of losses (or distortion 315 on FIG. 3). In a variant, the loss may be based on an “objective” metric, typically Mean Squared Error (MSE) or based on structural similarity (SSIM). The results may not be perceptually as good as the second type, but the fidelity to the original signal (image) is higher. In another variant, the loss may be based on “subjective” (or subjective by proxy), typically using Generative Adversarial Networks (GANs) during the training stage or advanced visual metric via a proxy NN.

In a related problematic, such ANN models are trained using several types of training sets. The same network can be first trained on a generic training set, allowing a satisfactory performance on a large range of content types, and then it is possible to fine tune the model using a specific training set for a specific usage, improving the performance on a domain specific content.

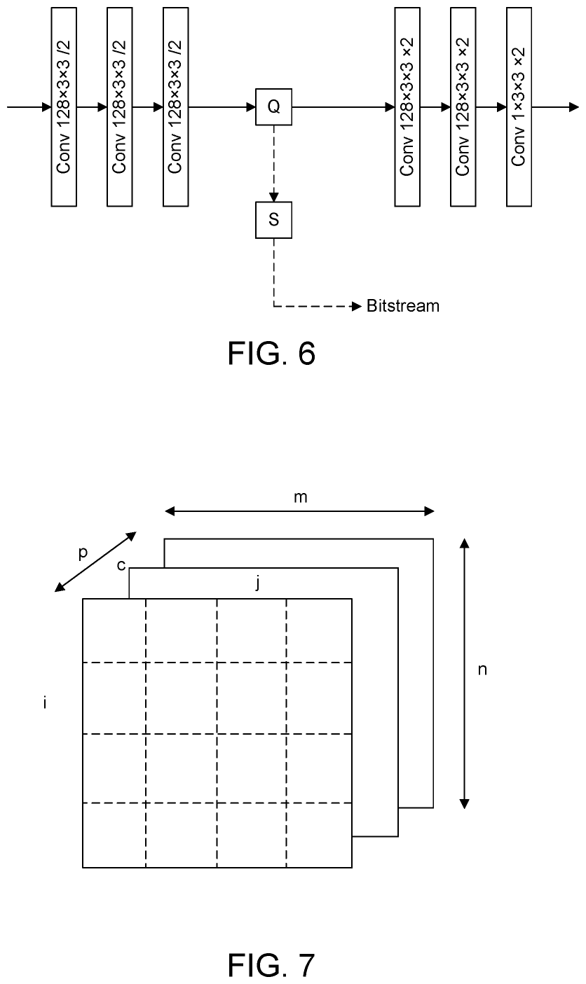

FIG. 6 illustrates a structural block diagram of the NN auto-encoder of the generic embodiment of FIG. 2. As described for the hyper-prior on FIG. 3, an input image is fed into the encoder, composed of 3 convolutional layers, each performing 128 3×3 2D-convolutions (with n=128 output channels), a down-sampling (denoted by/2), followed by an activation layer (for example a ReLU or a Generalized Divisive Normalization (GDN), etc.). The output of the last layer of the encoder is known as “latent representation” or “latent”. The coefficients of the latent are then quantized. The quantized coefficients are (losslessly) entropy coded to form the payload of the bitstream. At the decoder side, 2D-deconvolutions are performed to reconstruct the image, either using transpose convolutions or classic upscaling (denoted by x2) operators followed by a convolution.

In the embodiment of FIG. 3-5, an additional NN, called hyper-prior, is used to improve the entropy coding module S by predicting the probability distributions of each parameter of the latent. These methods allow to better predict the distribution by modulating the distribution estimations for each coefficient in the latent, compared with the generic factorized prior model as described above with FIG. 2 and FIG. 6 where all the latent coefficients of a given channel share the same prior. Another improvement consists in using an auto-regressive model to predict the prior of a given coefficient using the distribution parameters of previously coded neighboring latent coefficients, typically by using masked convolution. Both methods can be combined to further improve the entropy coding of the latent.

However, in practice, most methods use a separate model for each RD (Rate-Distortion) tradeoffs (corresponding to a different lambda λ in the loss optimization):

$$Loss = {E}_{( x \sim D )} [ - log ( {p}_{h} ( \hat{y} \vert ϕ ) ) + λ . d ( x , \hat{x} ) ]$$

### With:

x the input image
\hat{x} the reconstructed image
d (.,.) a distortion metric, typically the MSE
y the latent (output of the encoder)
ŷ the quantized latent
Φ the distribution parameters.

Thus, depending on the model architecture and the target lambda λ, the estimated distributions Φ may vary a lot from channel to channel. While some channels have a high entropy, other channels may not carry any information, i.e., they can consist of all-zero coefficients. Besides, the main drawbacks of hyper-prior methods are that they involve additional computations due to the additional NN run in parallel with the main NN and they induce an additional latency in the encoding/decoding processes since the decoding of the main latent cannot start before the end of the decoding of the hyper-latent. Considering the embodiment of auto-regressive encoder, it adds even more latency and breaks the parallelism of the approach due to the causal relationships between distribution parameters of the latent coefficient, then requiring a sequential encode/decode. Finally, during inference for a particular image, the RD optimality is an approximation from the parameters found during the training stage.

Therefore, there is a need to improve the entropy coding of the latent tensor.

At least some embodiments relate to a method for entropy encoding/decoding a latent tensor that improves the compression performance of existing auto-encoders without requiring retraining their parameters. At least some embodiments relate to retraining process and loss improvement are also presented. At least some disclosed embodiments allow to further reduce the remaining redundancies in the quantized latent.

FIG. 7 illustrates a representation of a latent tensor in a neural-network-based video compression system to which aspects of the present embodiments may be applied. In most neural network-based compression frameworks, the latent representation y is formed in 3-dimensional tensor (referred to as a latent tensor or latent). FIG. 7 shows an example of a latent y∈R^{m×n×p} of size (m×n×p): m×n depends on the input image size while the number of channel p is a property of the encoder. The encoder generates a latent L/y in a latent space of dimension R^{m×n×p} (also noted R\hat{ }(m×n×p)) where m, n, p are positive integer. On FIG. 7, the indices i, j, c indicates a respective position in the latent of dimension R^{m×n×p}. Besides, for each channel c in p range and for each value v at (i,j) in R^{m×n}, the encoder obtains the probability distribution D at (i,j,c) and entropy encode E the value v with H=E (v,D).

At decoder side, for each channel c of dimension R^{m×n} and for each position (i,j) in the channel c, the decoder obtains the current probability distribution D at (i,j,c) and entropy decode the value v using the symbol parsed from the bitstream b and E⁻¹ (b,D). For a fully factorized prior model, the distribution is only dependent on the channel c thus D(i,j,c)=D(c). The distribution can be stored as a parametric function or a complete CDF (cumulative distribution function) and shared between the encoder and the decoder. When using a hyperprior, and/or auto-regressive model, the parameters of the distribution function are updated for each value of the latent at (i,j,c). The default probability distribution of a channel is retrieved either directly from the training stage, or recomputed by a using a large dataset wherein for each sample in the large dataset, the sample is encoded. The resulting latent is retrieved and the values in the latent are accumulated in an histogram for each channel of the latent. At the end, the distribution is the normalized histogram for each channel. Alternatively, from the distribution, distribution parameters can be extracted (for example assuming a gaussian distribution).

At least some embodiments relate to a method for entropy encoding/decoding a latent based on the probability distribution of latent. Advantageously the latent entropy coding is improved by further reducing the redundancies in the quantized latent. To that end, at least one embodiment is described that:
takes into account channels importance by coding an indication of a channel activity (or significance);
perform post-conditional entropy coding by computing conditional probability based on a context afterwards;
use channels reordering to improve inter channel conditional entropy coding.
use a signaling on image/blocks.
Perform RDOQ like process by optimizing the main latent for a particular image.

Especially, the proposed mechanism and syntax improve the compression performance of existing auto-encoders without requiring retraining their parameters. Additionally, training and loss improvement are also presented.

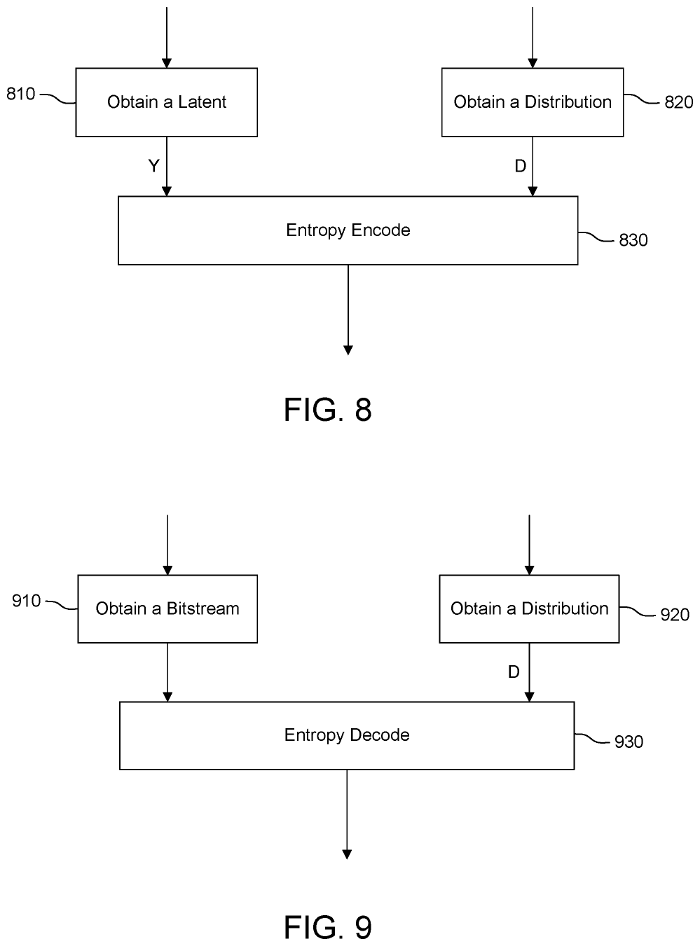

FIG. 8 illustrates a block diagram of a generic embodiment of an entropy encoding method in an end-to-end neural-network-based video compression scheme. In a step 810, a latent (Y) associated with image data using a neural network is obtained. The latent representation Y is formed by 3-dimensional tensor (referred to as a latent tensor). According to a variant illustrated on FIG. 7, the latent is formed by a number of p channels of two-dimensional data m×n. In the following, a spatial location in the 2D space are indicated by the reference indices (I,j) and a channel position by the indices c. In a step 820, a distribution, according to any of the variant described above is also used as an input of the entropy encoding. The probability distribution D(i,j,c) is determined for each value (v) of the latent, in a case of fully factorized data, the distribution only depends on the channel D(c). Then, in a step 830, the latent is quantized and entropy encoded based on the probability distribution of the latent to generate a as a binary stream (bitstream). According to various embodiments, the entropy encoding further includes at least one of obtaining an indication of an activity of a channel, obtaining a conditional probability distribution of the latent, reorders channels based on inter channel correlation or performs rate distortion optimization on the latent.

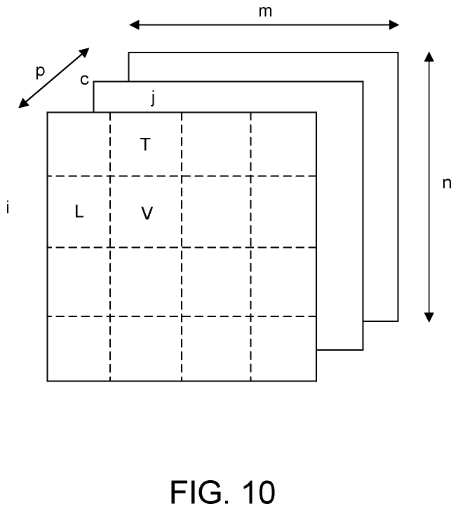

FIG. 9 illustrates a block diagram of a generic embodiment of an entropy decoding method in an end-to-end neural-network-based video compression scheme. The entropy decoding method mirrors the entropy encoding described above. In a step 910, a bitstream is obtained that contains NN based-coded data representative of latents (y) associated with image data. The latent representation Y is formed by 3-dimensional tensor (referred to as a latent tensor), for instance comprising a number of p channels of two-dimensional data m×n. In a step 920, a distribution, according to any of the variant described above is also used as an input of the entropy decoding. Then, in a step 930, the latent is dequantized and entropy decoded based on the probability distribution thus allowing reconstructing image data using NN-based decoding.

### According to a First Embodiment, an Indication of an Activity of a Channel is Signaled.

Since not all channels are necessarily activated for a particular content, in a first embodiment, it is proposed to add an information in the bitstream to indicate when a particular channel c in R\hat{ }(m×n×p) has values which need to be decoded, i.e., the current value is different from the most probable value of the distribution, e.g. the mean value in case of a Gaussian distribution.

Accordingly, in the encoder, a comparison between a current value v at (i,j,c) and the most probable value of the distribution D(i,j,c) or D(c) is performed. In case at least one current value is different from the most probable value of the distribution, the activity for the channel is positive (set to 1) and the channel is effectively coded. In case all values of the channel c are equal to the most probable value of the distribution, the activity A[c] is set to zero. the encoding of the channel is skipped. Besides, to signal to the decoder that the channel c has the most probable value, the channel activity indication is encoded.

Advantageously, the proposed activity table can be entropy coded using a prior probability on the activation of a particular channel. This probability can be computed using a large dataset to derive statistics on latent distributions. This can be done with the dataset used for training, wherein for each sample in the dataset, the sample is encoded and a latent is generated. For each channel of the latent, the channel is marked as activated if any value in the channel is different from the most probable value of the channel distribution. Finally, the channel activity probability is computed as the average probability over the dataset as for latent data.

At the decoder, the activity of the channel A[c] is decoded. When the decoded activity of the channel A[c] is positive (“1”), it indicates that the channel contains coded value, the channel is entropy decoded. When the channel activity A[c] is zero (“0”), the channel is initialized to the most probable value for this channel. In a variant embodiment, the channels of the latent are first sorted by activity, as detailed in the section related to channel reordering, from the most active channel to the least active channel. Instead of indicating the activity for each channel, an index of the last active channel is transmitted. According to yet another variant, this index is also entropy coded by using the probability computed on the training set as before.

### According to a Second Embodiment, a Conditional Probability Distribution of the Latent is Signaled.

FIG. 10 illustrates a representation of a latent tensor in a neural-network-based video compression system to which aspects of the present embodiments may be applied.

For a given model using a simple (not auto-regressive) probability model, the conditional probability for each value of a particular channel is computed. A context is computed for each value v at (i, j, c) depending on the causal neighboring values. As shown on FIG. 10, in a variant, one context (ctx) of a value (v) of the latent comprises at least one causal spatial neighboring value (T,L) in the same channel. In another variant, the at least one context (k) of a value (v) of the latent further comprises at least one causal inter channel neighboring value (P). In an embodiment the context is chosen as the number of values in the causal neighboring above a threshold f. In FIG. 10, we refer to T (top) and L (left) the values of the latent in the channel already decoded, the context ctx(f,T,L) is computed as:

$$If \vert T - μ \vert > f and \vert L - μ \vert > f : t = 2$$

$$Else if \vert T - μ \vert > f or \vert L - μ \vert > f : t = 1$$

$$Else t = 0$$

Where μ is the distribution average, or most probable value for the channel. In this example there are 3 contexts. In a variant, a context may be identified by an index k. For each context ctx, a probability distribution is associated where D(i,j,c)=cdf_{ctx}=p(v|t). In a variant, the conditional probability distribution can be computed from offline training on any dataset. Advantageously, the optimal threshold for each of the context modeling of a particular channel c can be computed offline using the optimization function:

$${f}^{*} = {arg}_{f} min \sum H ( v , {cdf}_{c t x ( f , T ( v ) , L ( v ) )} )$$

Where H is the entropy of the value v using the cdf cdfₖ, and k is the context index. The context index is computed as k=ctx(f, T(v), L(v)) where f is the threshold, T(v) and L(v) are the values of the top and left values of the current value v (values outside the latent tensor are considered 0 or any other arbitrary known value).

In another variant embodiment, the context also uses causal inter channels values. For example, the coefficient P at the same spatial position (i,j) in the previously decoded channel is used to compute the context:

$$c t x ( f , T , L , P ) = ( \vert T - μ \vert > f ) + ( \vert L - μ \vert > f ) + ( \vert P - {μ}^{′} \text{\textbar >} f )$$

Where μ′ is the distribution average, or most probable value for the channel containing P. In yet another variant, the thresholds are different depending on the neighbor location. In another embodiment, the use of the optimal conditional probability model for a given image, or region of an image, is computed at encoder side and signaled in the bitstream. The optimal conditional probability model is determined according to the rate in any of the disclosed model. At decoder side, the same model is used to entropy decode the values of the latent.

### According to a Third Embodiment, Channels of the Latent are Reordered Before Encoding.

In the previously described embodiment, inter channel dependent coding is performed using the original order of the channels in the latent tensor. However, since this order is not necessarily optimal for entropy coding, it is proposed in this variant embodiment to reorder the channels using a training dataset. This order is then fixed in the codec and known from the encoder and decoder.

The new order of channels encoding/decoding is then fixed for a particular coder/decoder. In another variant, the deep encoder or deep decoder may be adapted to generates/take as input a latent with the new channel order, accordingly the weights of the last layer of the encoder and first layer of the decoder may be adapted to take into account this new order for coding. In one embodiment, the coding order of the channels is chosen to maximize the correlations between successive channels. For example, the first channel in the reordered tensor is the channel with the highest average energy (e.g., which can be computed as the variance of the values of the channel's coefficients), averaged on a dataset. Then iteratively, the next channel is chosen as the channel having the highest correlation with the previous channel. For example, using the above optimization function that computes an optimal threshold f for the context for the current value, the correlation between channel n and m is computed as:

$$cor ( n , m ) = \sum \{ \begin{matrix}1 if v ( i , j , n ) > f and v ( i , j , m ) > f \\ 1 if v ( i , j , n ) \leq f and v ( i , j , m ) \leq f \\ 0 otherwise\end{matrix}$$

According to another variant embodiment, the channels may be ordered by decreasing average energy where the energy is defined as the sum of the square of the values in one channel.

According to yet another variant embodiment, the channels may be ordered by decreasing average activity with the activity defined as the sum of the values greater than a threshold f.

According to yet another variant embodiment, the channels are ordered by searching iteratively the order which minimizes the coding cost using the context defined in the previous embodiment.

According to a Fourth Embodiment, a Syntax is Disclosed that Enables Signaling Channel Activity.

According to different variants, the channel activity signaling may be done at frame, or block/tile level. The table below shows an example of header for the encoding of the latent:

| | |
|---|---|
| width_minus_one | ue(v) |
| heigth_minus_one | ue(v) |
| nb_channels_minus_one | ue(v) |
| decimation_factor | ue(v) |
| for c in 0..P−1 | |
| channel_activation[c] | ae(v) |
| if channel_activation[c] | |
| for i in 0..m−1 | |
| for j in 0..n−1 | |
| v(i,j,c) | ae(v) |

Where the signaled width and height are the original image width and height, P being the number of the number of channels of the latent at the decoder input, and c the channel index in the latent, and decimation factor is the spatial decimation performed by the encoder on the original image to get the latent spatial dimension m×n.

To recover the input latent width and height, a padding is applied on the original image, for example:

$$m = ( height\_minus \_one + 1 + padding - 1 ) // padding$$

where padding=2\hat{ }decimation_factor and//denotes the integer division. It means that original image is padded, for example the new padded image height is:

$${H}^{′} = m * padding$$

Typically, the padding can be done by centering the image and pad with 0 values outside. In a variant the original image is in the top-left. After reconstruction, the output image is cropped accordingly to the input image padding policy.

The latent values for non-activated channels are taken as the most probable one in the cdf distribution.

In a variant, a block level signaling is performed. In yet another variant, the activity channel for each block uses a conditional probability depending on the activity of the last coded block, the first block using the same coding as above.

### According to a Fifth Embodiment, a Rate Distortion Optimization of the Latent is Performed.

In traditional codec, a well-known method to optimize the coding of the coefficient of the transformed and quantized residuals is the Rate-Distortion-Optimized-Quantization (RDOQ). A relation between a modification of quantization of the coefficients and the modification of the distortion is used. It allows to slightly change the quantized coefficients for a particular residual in order to optimize the rate distortion RD metric: C=R+λD where R is a measure of the rate of the residuals, λ the lagrangian multiplier and D a measure of the distortion.

In order to adapt the RDOQ to the coding of the latent, an iterative process is used. In a first step, a part of an image is encoded using the NN-coder part of the auto-encoder. It produces the main latent Y. Then, for each channel c in the latent Y, and for each value v (or coefficient) at a coordinate (i,j) in the channel c, the value is modified by adding an offset value, thus resulting in a modified latent. Then, the image is reconstructed from the modified latent, and a distortion D′ with the original image is computed, as well as the new cost C′=R+λD′ is computed. Then the new cost is compared with the previous cost C. If the new cost C′ is smaller than the previous cost C, the modified value is kept in the latent. The process iteratively performed for each value in the latent. As only the variation of C is needed, according to a variant, instead of computing the full rate of the latent, only the rate induced by the modified value is used. Advantageously, the complexity of the process is reduced.

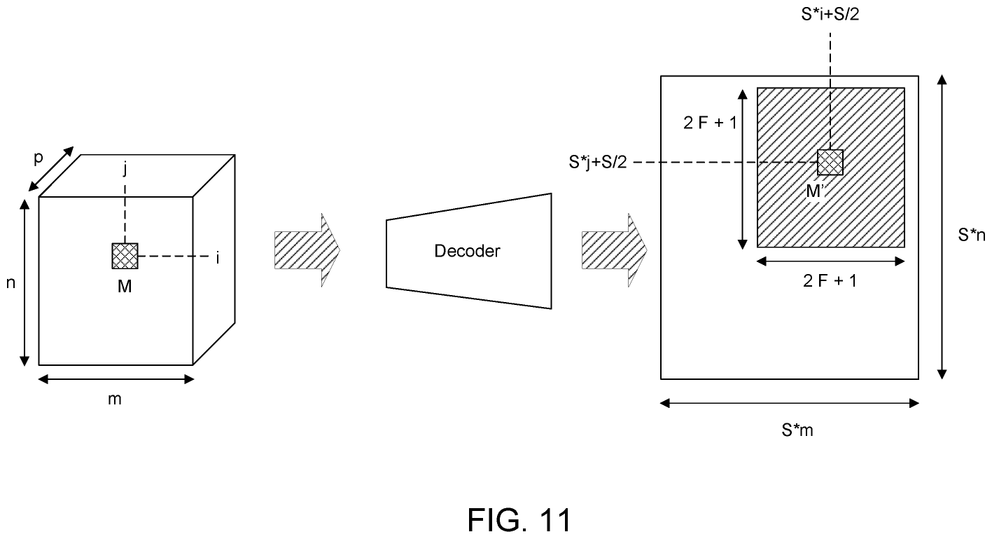

FIG. 11 illustrates a representation of a receptive field of latent tensor according to at least one embodiment related to RDOQ. In FIG. 11, for a given auto-decoder, a coefficient of the latent at coordinate (i,j) spatially, the corresponding coordinates are (S*i+S/2,S*j+S/2) in the output with S being an upscale factor between spatial latent dimension and the reconstructed image (corresponding to the previously mentioned decimation factor). For a receptive field of F, the area of size (2F+1)×(2F+1) centered on M′ corresponds to the samples in the output image which are modified when the value at M in the latent is modified.

According to a particular embodiment, the RDOQ process is optimized by decoding only a part of the latent comprising the modified value depending of the receptive field of the decoder. Advantageously, the process is speed-up. That is, instead of running the decoder on the full latent, only a part of the latent, containing the modified value (or coefficient), is used. Indeed, a given modified coefficient in the latent, only a part of the reconstructed image is modified, depending on the receptive field of the decoder.

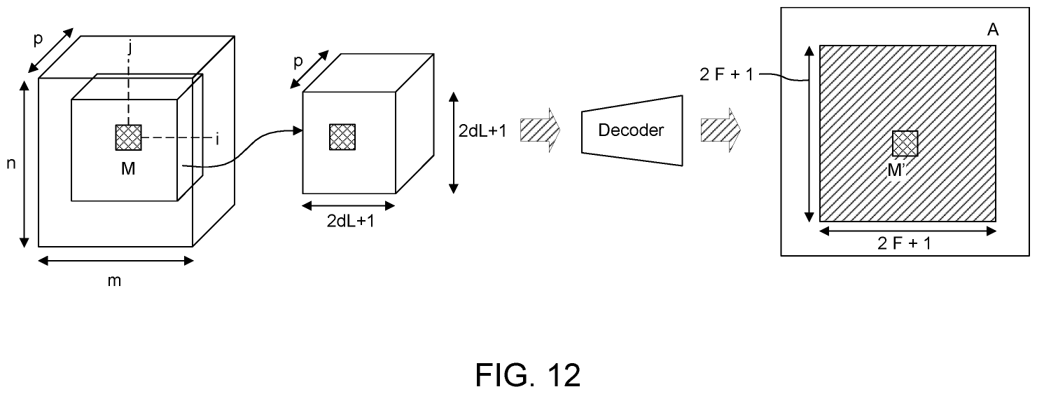

FIG. 12 illustrates another representation of a receptive field of latent tensor according to at least one embodiment related to RDOQ wherein only y a part of the latent is decoded. For a given decoder with a receptive field of F and an upscale factor of S (ie the final image size is spatially S times larger than the input latent), the size of the latent to crop inside the original latent is given by:

$$d L = ceil ( \frac{( F \cdot 2 )}{S} )$$

Where ceil(x) is the function computing the smallest integer that is greater or equal to x. The cropped latent is then of size (2*dL+1)×(2*dL+1)×p, centered spatially around the current value at coordinates (i,j,p) being process in the original latent.

When using a cropped latent, only the distortion of the resulting patch A of size (2F+1)×(2F+1) at the reconstructed image center is used as shown on FIG. 12. As previously for the rate, as only the difference of the distortion between the modified reconstructed image and the previously reconstructed image is involved in the RDOQ comparison, such approximation does not challenge the RDOQ process.

In yet another variant, to further speedup the process, an approximation is done by reducing the theoretical receptive field by a factor. For example, instead of using F in the above process, F/2 or F/3 is used as an approximation.

According to a particular embodiment, the RDOQ process is speedup using parallel processing. In a variant, each channel is processed independently and in parallel processes. Each time a value of the latent is updated, all parallel processes update their latent. The skilled in the art will note that this process becomes non-deterministic since the parallel processing order is not controlled. The updated values are still shared between the processes. In another variant, the parallel processing is done on the same channel by splitting the latent spatially into several parts.

According to a particular embodiment, the parallel RDOQ is iterated with the approximation of the reduced receptive field. In order to improve the results of the parallel processing, the whole process is iterated several times in order to converge towards a better latent value. For example, in multithread, at each pass, the whole latent is modified. When all processes are finished, a second pass is started on this latent. Further passes can be done until convergence is reach, for example when the modification of the total cost C is below a given value. The table below shows an example of tradeoff of the presented methods:

| | PSNR | Rate | RDOQ | |
|---|---|---|---|---|
| Method | (dB) | (bpp) | time | |
| original | 32.6034 | 0.315362 | 0 | mn |
| 1 pass, exact receptive field, no thread | 32.7609 | 0.309789 | 100 | mn |
| 1 pass, exact receptive field, | 32.7731 | 0.3134 | 7 | mn |
| multithread | | | | |
| 1 pass, approximate receptive field, | 32.7922 | 0.311289 | 3 | mn |
| multithread | | | | |
| 3 passes, approximate receptive field, | 32.8223 | 0.306403 | 7 | mn |
| multithread | | | | |

According to a particular embodiment, additional heuristics can be used in order to speedup or improve the performance of the parallel RDOQ. According to a non-limiting example, if available, the gradient of the output with respect to the input latent in the decoder can be used to guide the latent coefficients to update in the process. Thus, the variation of distortion with regard to the variation of latent can be computed and the optimal latent update with regard to this gradient can computed by minimizing the cost C. In another example, in order to first improve the rate, the step for each value of the latent is chosen such as it reduces the rate. The cost C is then computed, and the value updated if the cost is smaller than the original cost.

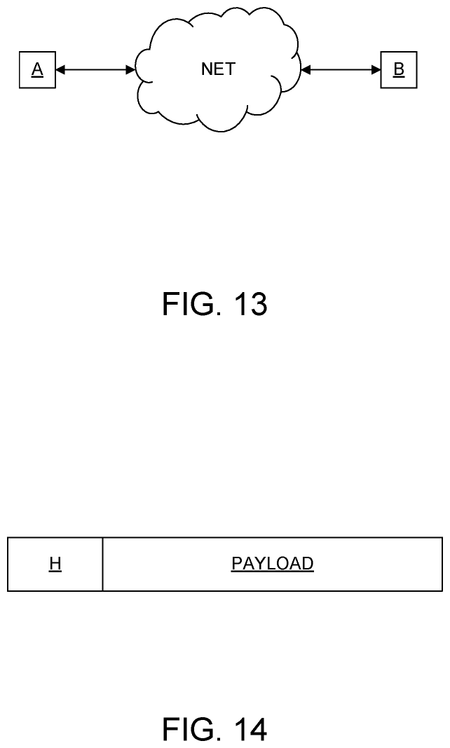

FIG. 13 shows two remote devices communicating over a communication network in accordance with an example of present principles in which various aspects of the embodiments may be implemented. According to an example of the present principles, illustrated in FIG. 17, in a transmission context between two remote devices A and B over a communication network NET, the device A comprises a processor in relation with memory RAM and ROM which are configured to implement any one of the embodiments of the method for NN encoding as described in relation with the FIG. 2, 3, 4, 6, 8 and the device B comprises a processor in relation with memory RAM and ROM which are configured to implement any one of the embodiments of the method for NN decoding as described in relation with FIG. 2, 3, 5, 6, or 9. In accordance with an example, the network is a broadcast network, adapted to broadcast/transmit encoded images from device A to decoding devices including the device

B. A signal, intended to be transmitted by the device A, carries at least one bitstream comprising coded data representative of at least one image along with metadata allowing to apply the entropy coding improvement information.

FIG. 14 shows an example of the syntax of such a signal when the at least one coded image is transmitted over a packet-based transmission protocol. Each transmitted packet P comprises a header H and a payload PAYLOAD. The payload PAYLOAD may carry the above described bitstream including metadata relative to signaling channel activity. In a variant, the payload comprises neural-network based coded data representative of image data samples and associated metadata, wherein the associated metadata comprises at least one of an indication of channel activity.

It should be noted that our methods are not limited to a specific neural network architecture, for example, the one shown in FIG. 3 know as a hyperprior model. Instead, our methods can be used in other neural network architectures, for example, fully factorized neural image/video model, implicit neural image/video compression model, recurrent network based neural image/video compression model or Generative Model based image/video compressing methods.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video encoding, comprising:
obtaining a latent associated with image data using a neural network, the latent comprising a number of channels of two-dimensional data;
obtaining a probability distribution for each value of the latent; and
entropy encoding the latent based on the probability distribution of the latent;
wherein the entropy encoding further includes at least one of:
signaling an indication of an activity of a channel,
obtaining a conditional probability distribution of the latent, and
channel reordering.

2. The method of claim 1, wherein the method further comprises:
obtaining a channel activity indication, wherein for a current channel of the latent, the channel activity indication of the current channel indicates that at least one value of latent is different from a most probable value in the probability distribution for that value of the latent;
obtaining a probability distribution of the channel activity indication;
entropy encoding the channel activity indication based on the probability distribution of the channel activity indication, and
wherein entropy encoding the latent comprises encoding only channels with a positive indication of a channel activity.

3. The method of claim 2, wherein the method further comprises
sorting the channels of the latent according to a value of the probability distribution of the channel activity indication; and
wherein the sorted latent is entropy encoded based on the probability distribution of the latent.

4. The method of claim 3, wherein entropy encoding the channel activity indication based on the probability distribution of the channel activity indication further comprising:
determining an index of a last active channel in the sorted latent, and
entropy coding the index of the last active channel based on the probability distribution of the channel activity indication.

5. The method of claim 1 wherein the method further comprises
obtaining at least one context of a value of the latent,
obtaining a conditional probability distribution for each context of each value of the latent; and
wherein the latent is entropy coded based on the conditional probability distribution of the latent.

6. The method of claim 5, wherein the at least one context of a value of the latent comprises at least one causal spatial neighboring value in a same channel.

7. The method of claim 5 wherein the at least one context of a value of the latent further comprises at least one causal inter channel neighboring value.

8. The method of claim 5, further comprising:
determining an optimal conditional probability distribution among the at least one context; and
wherein the latent is entropy coded based on a best conditional probability distribution of the latent.

9. The method of claim 1, wherein the method further comprises
sorting the channels of the latent according to a channel order; and
wherein the sorted latent is entropy coded based on the probability distribution of the latent.

10. The method of claim 9, wherein the channel order is fixed and obtained from an offline training.

11. The method of claim 10, wherein the channel order is obtained by maximizing a correlation between successive channels of the latent.

12-16. (canceled)

17. A method of video decoding, comprising:
obtaining coded data representative of latents associated with image data, the latent comprising a number of channels of two-dimensional data;
obtaining a probability distribution for each value of the latent; and
entropy decoding coded data based on the probability distribution of the latent to reconstruct the latent;
wherein the entropy decoding further includes at least one of:
obtaining an indication of an activity of a channel,
obtaining a conditional probability distribution of the latent,
channel reordering.

18-20. (canceled)

21. The method of claim 17, wherein the method further comprises:
entropy decoding a channel activity indication based on a probability distribution of the channel activity indication, wherein for a current channel of the latent, the channel activity indication of the current channel indicates that at least one value of latent is different from a most probable value in the probability distribution for that value of the latent; and
wherein entropy decoding the latent comprises decoding only channels with a positive indication of a channel activity.

22. The method of claim 21, wherein value of the channels with a negative indication of a channel activity are set to the most probable value.

23. The method of claim 17 wherein the method further comprises
obtaining at least one context of a value of the latent,
obtaining a conditional probability distribution for each context of each value of the latent; and
wherein the latent is entropy decoded based on the conditional probability distribution of the latent.

24. The method of claim 23, wherein the at least one context of a value of the latent comprises at least one causal spatial neighboring value in a same channel.

25. The method of claim 23 wherein the at least one context of a value of the latent further comprises at least one causal inter channel neighboring value.

26. The method of claim 17, wherein entropy decoded latent is a sorted latent, wherein the channels of the latent are sorted according to a channel order.

27. The method of claim 26, wherein the channel order is fixed and obtained from an offline training.

28. An apparatus, comprising one or more processors and at least one memory coupled to said one or more processors, wherein said one or more processors are configured to perform the method of claim 1.
